(19) United States
(12) Patent Application Publication
(10) Pub. No.: US 2022/0355855 A1
(43) Pub. Date: Nov. 10, 2022

(54) System for a Vehicle that Compensates for Vehicle Spin

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/869,833

(22) Filed: Jul. 21, 2022

Related U.S. Application Data
(60) Provisional application No. 63/224,798, filed on Jul. 22, 2021.

(51) Int. Cl. B62D 6/00; B62D 5/04

(52) U.S. Cl. CPC B62D 6/001; B62D 5/0418

(57) ABSTRACT

A system of an electric vehicle configured to compensate for spin of the electric vehicle that results from slipping of one or more wheels. A controller detects when one or more wheels are slipping and/or a spin (e.g., rotation) of the electric vehicle that results from a torsion force as a result of the slipping. The controller instructs the steering system to orient one or more of the wheels that are not slipping in a direction opposite the direction of rotation to attempt to reduce or eliminate rotation of the electric vehicle and/or to maintain the present direction of travel.

### BACKGROUND

Embodiments of the present invention relate to a steering system for a vehicle.

Vehicle drivers would benefit from a steering system that compensates for vehicle spin that results from wheel slip on surfaces that provide different traction.

### SUMMARY

An example embodiment of an electric vehicle of the present disclosure, includes a steering system and a traction motor for each wheel of the electric vehicle. The traction motors and the steering systems cooperate with a controller and sensors to detect when one or more wheels have lost traction and are spinning and when, as a result of the loss of traction, the electric vehicle is beginning to spin (e.g., rotate).

A controller receives information from sensors, the traction motors, and/or the steering systems to be able to detect wheel spin and rotation of the electric vehicle. Upon detecting wheel spin and rotation of the electric vehicle, the controller instructs one or more of the steering systems of the wheels that are not spinning to orient their wheels in a direction that will eliminate or decrease the spin of the electric vehicle and to keep the electric vehicle, if possible, traveling in the present direction of travel.

As the wheels that were spinning regain traction and the torsion force causing the vehicle to spin is reduced, the controller instructs the steering systems to return their respective wheels back to their original position prior to the start of spin.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a block diagram of an example embodiment of the systems of an electric vehicle of the present disclosure.

FIG. 2 is a diagram of a first orientation of linear accelerometers.

FIG. 3 is a diagram of a second orientation of linear accelerometers.

FIG. 4 is a diagram of orientation of gyroscopes and detecting a torsion force that results in spin of the vehicle.

FIG. 5 is a diagram of a wheel for detecting a linear velocity of the wheel.

FIG. 6 is a block diagram of FIG. 1 that indicates the RPM and linear velocity of each wheel.

FIGS. 7-11 are block diagrams of the electric vehicle of the present disclosure and conditions of wheel slippage, a torsion force and steering correction to compensate.

FIG. 12 is a block diagram of a range of orientation of the wheels.

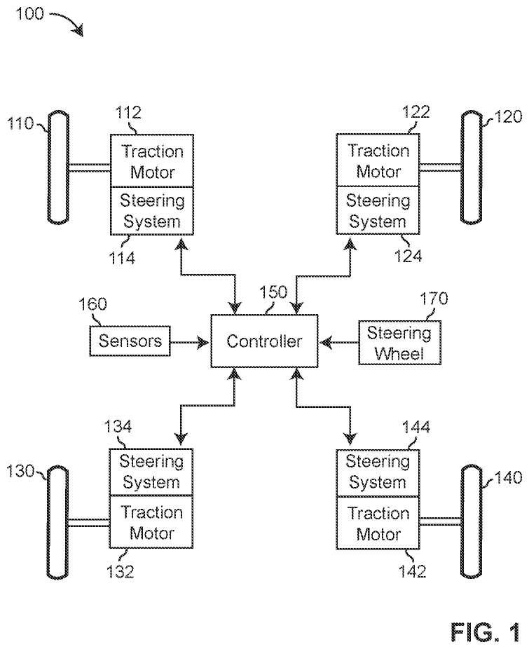

### DETAILED DESCRIPTION

### Overview

An example embodiment of the present disclosure relates to the drive systems (e.g., 112, 122, 132, 142) and the steering systems (e.g., 114, 124, 134, 144) of an electric vehicle 100. The drive systems provide the power to turn the wheels (e.g., 110, 120, 130, 140) to cause the electric vehicle to move. The steering systems orients the wheels to travel in a desired direction. The drive systems may cooperate with the steering systems to enable the electric vehicle 100 to continue traveling in the present direction of travel when the wheels experience slip that results in a torsion force on the electric vehicle 100 that rotates (e.g., spins) the electric vehicle 100.

In an example embodiment, the electric vehicle 100 includes four wheels 110, 120, 130, 140, four traction motors 112, 122, 132, 142, four steering systems 114, 124, 134, 144, a controller 150, sensors 160, and a steering wheel 170. Each traction motor and each steering system is associated with one wheel respectively. The traction motor provides power to turn (e.g., rotate) the wheel. The steering system orients the wheel so the vehicle may drive (e.g., move) in a direction. Each wheel may be turned by its respective traction motor independent of the other wheels. Each wheel may be oriented by its respective steering system independent of the other wheels. The controller may control and/or coordinate the operation of the four traction motors and/or the four steering systems.

The sensors 160 detect physical properties. The sensors 160 provide data (e.g., information) regarding the detected properties to the controller 150. The data from the sensors 160 includes information regarding acceleration of the electric vehicle 100 in a direction and/or rotation (e.g., rotation around its center) of the electric vehicle 100. The traction motors 112, 122, 132, and 142 may further provide data to the controller regarding the rate at which a wheel is turning (e.g., revolutions per minute, RPM). The traction motor and or the controller 150 may use information regarding the RPMs of each wheel to determine the linear velocity (e.g., speed) of each wheel. The controller 150 may use data from the sensors 160 and also the data from the traction motors 112, 122, 132, and 142 to determine whether a wheel is slipping, or other words has lost traction with the surface over which it travels. The controller 150 may further determine whether the wheel slip has resulted in a torsion force on the electric vehicle 100 that is or will cause rotation (e.g., spinning) of the electric vehicle 100.

When one or more wheels slip, the controller may use the data it receives or the data it calculates to control the steering systems 114, 124, 134 and 144 to attempt to maintain the present direction of travel of the electric vehicle 100 in spite of the slipping wheels. The controller 150 may operate one or more steering systems to compensate for the torsion force acting on the electric vehicle 100 in an attempt to keep the electric vehicle 100 from spinning and in particular from spinning out of control.

### Steering Wheel

The steering wheel 170 may be a mechanical steering wheel or part of a fly-by-wire steering system. The driver controls the movement of the steering wheel 170. The driver uses the steering wheel 170 to indicate the direction in which the driver would like the electric vehicle 100 to travel. The steering wheel 170 provides data to the controller 150 regarding its position, rotation, direction of rotation and/or rate of rotation. The controller 150 uses the data from the steering wheel 170 at least in part to control the steering systems 114, 124, 134 and 144. Because the controller 150 can use data from the sensors 160 and data from the traction motors 112, 122, 132 and 142 to control the steering systems 114, 124, 134 and 144, the steering wheel 170 does not, in some circumstances or possibly for a limited time, have complete control over the steering systems 114, 124, 134 and 144, and at times possibly the direction of travel of the electric vehicle 100.

### Controller

The controller 150 receives data from the sensors 160, the traction motors 112, 122, 132 and 142, and the steering wheel 170. The controller 150 may further receive data from the steering systems 114, 124, 134 and 144. The controller 150 may perform calculations using received data and/or data stored in a memory. The controller 150 may use some or all of the data it receives and/or calculates to control the other systems of the electric vehicle 100, including, inter alia, the steering systems 114, 124, 134 and 144 and the traction motors 112, 122, 132 and 142. The controller 150 may send data and/or control signals to the traction motors 112, 122, 132 and 142 and/or the steering systems 114, 124, 134 and 144. The data and/or control signals sent by the controller 150 to another system may control the operation of the other system in whole or in part.

The controller 150 may include any electric, electronic and/or electromechanical (e.g., solenoid, relay) devices. The controller 150 may include a processing circuit (e.g., microprocessor, signal processor bus, computer), a memory (e.g., magnetic, semiconductor), one or more buses (e.g., address/data, control area network bus, local interconnect network) for communicating (e.g., sending, transmitting, receiving, sensing) data and/or providing control data and/or signals for controlling another system.

### Sensors

The sensors 160 detect (e.g., sense, capture) data regarding physical properties. Physical properties include, inter alia, physical properties related to movement (e.g., velocity, acceleration, angular velocity, angular acceleration, mass, momentum), position (e.g., orientation, distance) and electrical characteristics (e.g., capacitance, conductivity, impedance, frequency).

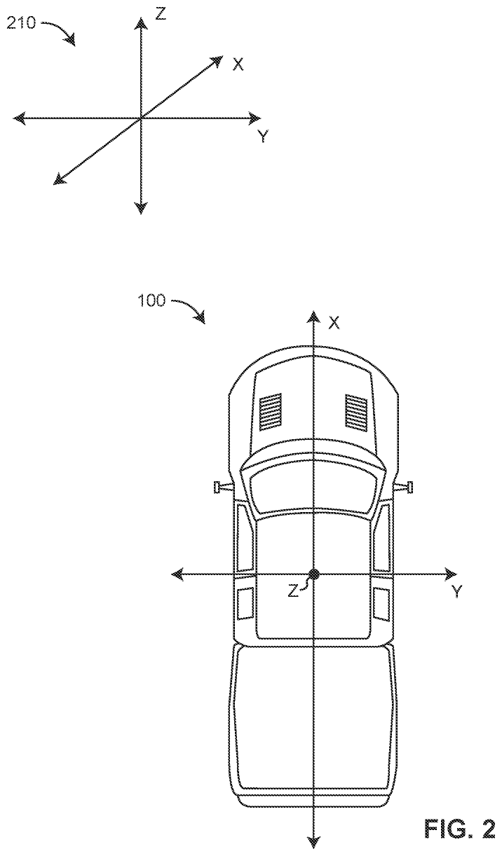

In an example of embodiment, the sensors 160 include linear accelerometers arranged to measure acceleration along the X, the Y and the Z axes of three-dimensional Cartesian coordinate system 210. In this example embodiment, the three-dimensional accelerometers are oriented with respect to the electric vehicle 100 so that the X axis of the accelerometers is oriented from front to back of the electric vehicle 100, as best shown in FIG. 2, the Y axis of the accelerometers is oriented from side to side, and the z-axis of the accelerometers is oriented vertically. The controller 150 may use data from the three-dimensional accelerometers to determine the acceleration, velocity (e.g., speed), position and/or direction of travel of the electric vehicle 100 in any direction.

The accelerometer oriented along the x-axis directly relates to the acceleration and/or the velocity of the electric vehicle 100 in the forward and/or backward directions. Data from the accelerometers oriented along the x-axis and the y-axis may be used to calculate the acceleration, velocity, position and/or direction of travel in any direction, not just forward or backward. In normal use, the data from accelerometer that collects data along the z-axis may be less important since the vehicle is limited to traveling along the surface of roads thereby limiting its overall movement in the up and down directions.

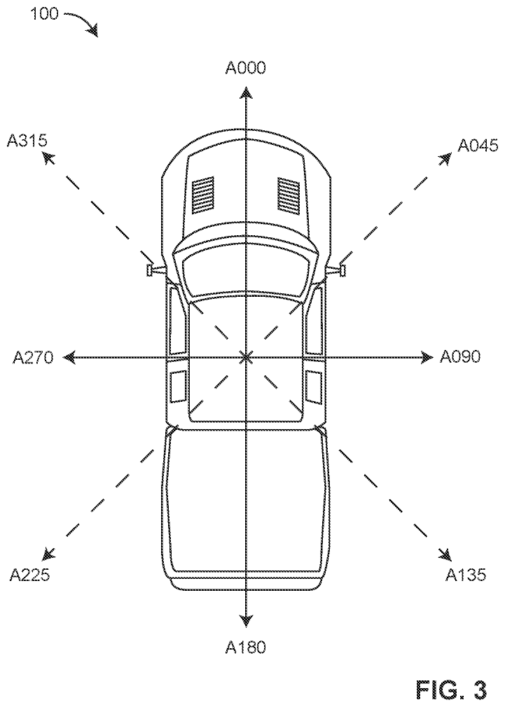

In another example embodiment, as best shown in FIG. 3, the sensors 160 include accelerometers oriented along the cardinal directions of the compass. In an example embodiment, eight accelerometers are oriented in the 0-degree direction A000 (e.g., forward), the 45-degree direction A045, the 90-degree direction A090 (e.g., right-side), the 135-degree direction A135, 180-degree direction A180 (e.g., rearward), the 225-degree direction A225, the 270-degree direction A270 (e.g., left-side) and the 315-degree direction respectively. Because there are more accelerometers providing data that is directly related to different directions of travel, the computational complexity of determining the acceleration, velocity, position and direction of travel of the electric vehicle 100 may be reduced. The arrangement shown in FIG. 3 may be accomplished by using two 3D-accelerometers, as discussed above, with their x-axes offset by 45 degrees.

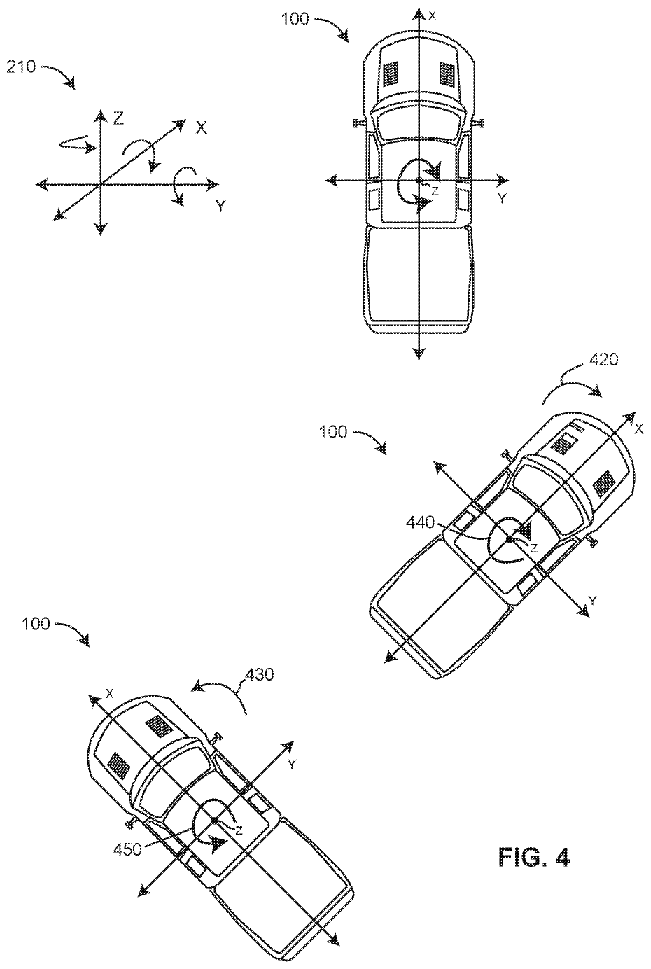

In an example embodiment, the sensors 160 may further include three gyroscopes arranged to measure rotation around the X, the Y and the Z axes of the three-dimensional Cartesian coordinate system 210. In an example embodiment, one gyroscope measures rotation around the X axis, one gyroscope measures rotation around the y-axis and one gyroscope measures rotation around the z-axis. The data measured with respect to the z-axis is relevant to determining whether the electric vehicle 100 is spinning (e.g., rotating). The data measured by the gyroscope with respect to the z-axis may provide information as to a direction of rotation of the torsion force. For example, as best seen in FIG. 4, the direction of rotation of a torsion force 440 is clockwise whereas the direction of rotation of a torsion force 450 is counterclockwise. The data from the x-axis and y-axis may be less important in conditions of normal operation. In another example embodiment, the sensors 160 includes a single gyroscope that measures rotation around the z-axis as seen in FIGS. 3 and 4.

A force around the z-axis or a force that results in rotation of the electric vehicle 100 around the z-axis is referred to as a torsion force. A torsion force may cause the electric vehicle 100 to rotate (e.g., spin) in the direction (e.g., clockwise, counterclockwise) of the force. The torsion force 450 in the counterclockwise direction causes the electric vehicle 100 to rotate around the z-axis in the counterclockwise direction. Likewise, a torsion force 430 is a rotational force in the counterclockwise direction with respect to the z-axis that causes the electric vehicle 100 to rotate in the counterclockwise direction around the z-axis. The gyroscope oriented to detect rotation around the z-axis detects rotations of the electric vehicle 100 caused by rotational forces such as the torsion force of 420 and 430. Accordingly, detecting rotation around the z-axis is an indication that a torsion force is acting or has acted on the electric vehicle 100.

The sensors 160 provide data to the controller 150. The controller 150 uses the data to determine (e.g., calculate) the acceleration, the direction of acceleration, the velocity and/or the position (e.g., including angular orientation) of the electric vehicle 100. The controller 150 may measure the forces that act on the electric vehicle 100 as result of the traction motors 112, 122, 132 and 142, the steering systems 114, 124, 134 and 144, and/or the braking systems (not shown). The controller 150 may use data from the sensors 160 to determine when a torsion force acts on the electric vehicle 100.

### Steering Systems

The steering systems 114, 124, 134 and 144 control the orientation of the wheels 110, 120, 130 and 140 respectively. The steering systems 114, 124, 134 and 144 may operate independent of each other. The steering systems 114, 124, 134 and 144 may set the angle of orientation of the wheels 110, 120, 130 and 140 independently of each other. In other words, the back wheels 130 and 140 and/or the front wheels 110 and 120 are not limited to being oriented parallel to each other. For example, the wheel 130 may be oriented in one direction, for example straightforward, while the wheel 140 is oriented in another direction, for example to the right. The steering systems 114, 124, 134 and/or 144 may turn their respective wheels 110, 120, 130 and 140 in any direction independent of the other wheels.

The steering systems 114, 124, 134 and 144 may be controlled by the controller 150. The controller 150 may control the steering systems 114, 124, 134 and 144 in accordance with data received from the sensors 160, the traction motors 112, 122, 132 and 142 and/or the steering systems 114, 124, 134 and 144. Data from the steering systems 114, 124, 134 and 144 may include a present orientation of the wheel 110, 120, 130 and 140 respectively.

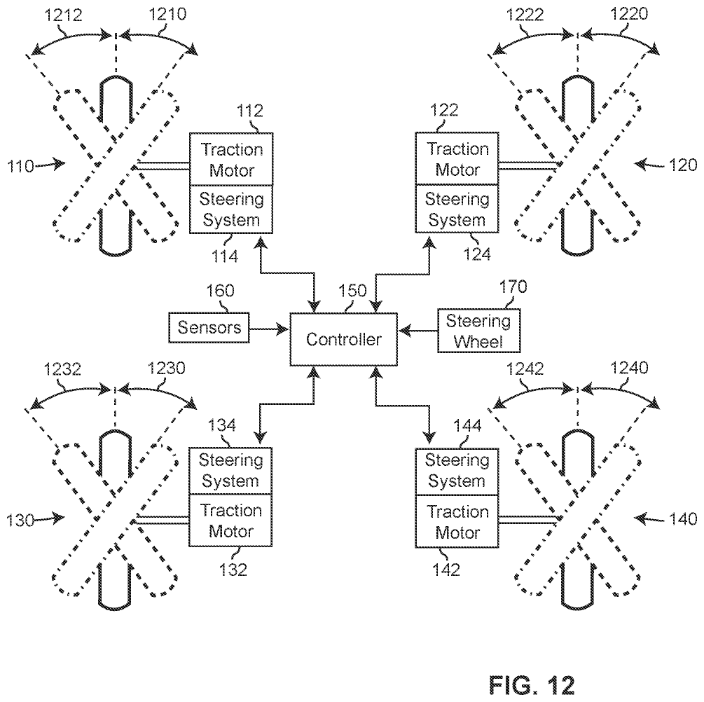

The controller 150 may control the orientation of the wheels 110, 120, 130 and 140 within a range. For example, as best seen in FIG. 12, the x-axis of the Cartesian coordinate system 210 is oriented along a length of the electric vehicle 100. A wheel may be oriented at any angle between straight ahead (e.g., parallel with the x-axis), an angle rightward (e.g., clockwise orientation) and an angle leftward (e.g., counterclockwise orientation). For example, wheel 110 may be oriented at any angle between straight ahead, rightward up to angle 1210 (e.g., a maximum rightward angle) and leftward up to angle 1212 (e.g., a maximum leftward angle). Wheel 120 may be oriented at any angle between straight ahead, rightward up to angle 1220 and leftward up to angle 1222. Wheel 130 may be oriented at any angle between straight ahead, rightward up to angle 1230 and leftward up to angle 1232. Wheel 140 may be oriented at any angle between straight ahead, rightward up to angle 1240 and it's leftward up to angle 1242.

As discussed above, the orientation of the wheels 110, 120, 130 and 140 may be independent of each other. The rightward and leftward maximum angles for each tire may be the same or different. For example, for front wheels 110 and 120, the angle 1210 may be equal to the angle 1220, while the angle 1212 may be equal to the angle 1222. For rear wheels 130 and 140, the angle 1230 may be equal to the angle 1240, while the angle 1232 may be equal to the angle 1242. In an example embodiment, the angles 1230 1232, 1240, and 1242 are less than the angles 1210, 1212, 1220, and 1222. For example, the angles 1210, 1212, 1220, and 1222 are equal to 40 degrees whereas the angles 1230 1232, 1240, and 1242 are equal to 15 degrees. In another example embodiment, the angles 1210 through 1242 are equal.

### Traction Motors

The traction motors 112, 122, 132 and 142 are connected (e.g., directly, indirectly) to the wheels 110, 120, 130 and 140 respectively. In an example embodiment, the traction motors 112, 122, 132 and 142 are directly connected to the wheels 110, 120, 130 and 140 respectively. In another example embodiment, the traction motors 112, 122, 132 and 142 connect to the wheels 110, 120, 130 and 140 respectively via a transmission. The traction motors 112, 122, 132 and 142 provide a force for rotating the wheels 110, 120, 130 and 140 respectively in either a clockwise or a counterclockwise direction. The traction motors 112, 122, 132 and 142 may accelerate, decelerate or maintain the rotations of the wheels 110, 120, 130 and 140 respectively. The traction motors 112, 122, 132 and 142 may measure their own respective rates of rotation (e.g., RPM), change in rate of rotation and/or direction of rotation. In an embodiment, the traction motors 112, 122, 132 and 142 may calculate a linear velocity of the wheels 110, 120, 130 and 140 respectively. The traction motors 112, 122, 132 and 142 may report any data detected, measured and/or calculated to the controller 150.

The traction motors 112, 122, 132 and 142 may operate independent of each other. The controller 150 may control the operation of the traction motors 112, 122, 132 and 142. The controller 150 may control the speed of rotation, the direction of rotation, rate of acceleration and rate of deceleration of the traction motors 112, 122, 132 and 142. Even though the traction motors 112, 122, 132 and 142 may operate or be operated independent of each other, the controller 150 may control the operation of the traction motors 112, 122, 132 and 142 to coordinate their operation. The controller 150 may further control the operation of the steering systems 114, 124, 134 and 144 to coordinate the operation of the traction motors and the steering systems. The controller 150 may coordinate the operation of the traction motors 112, 122, 132 and 142 and the steering systems 114, 124, 134 and 144 to reduce a torsion force on the electric vehicle 100.

Coordinating the operation of the traction motors and the steering systems does not mean that each traction motor and each steering system is performing the same operation. Coordinating the operation of the traction motors and the steering systems to reduce a torsion force on the electric vehicle 100 may mean that some traction motors rotate at different RPMs well some steering systems orient their respective wheels at different angles.

In an embodiment, the controller 150 stores information regarding the radius of the wheels 110, 120, 130 and 140. The controller 150 receives the rate of rotation (e.g., RPMs) from the traction motors 112, 122, 132 and 142 and calculates the linear velocity of the wheels 110, 120, 130 and 140 respectively.

### Determining the Velocity of the Electric Vehicle

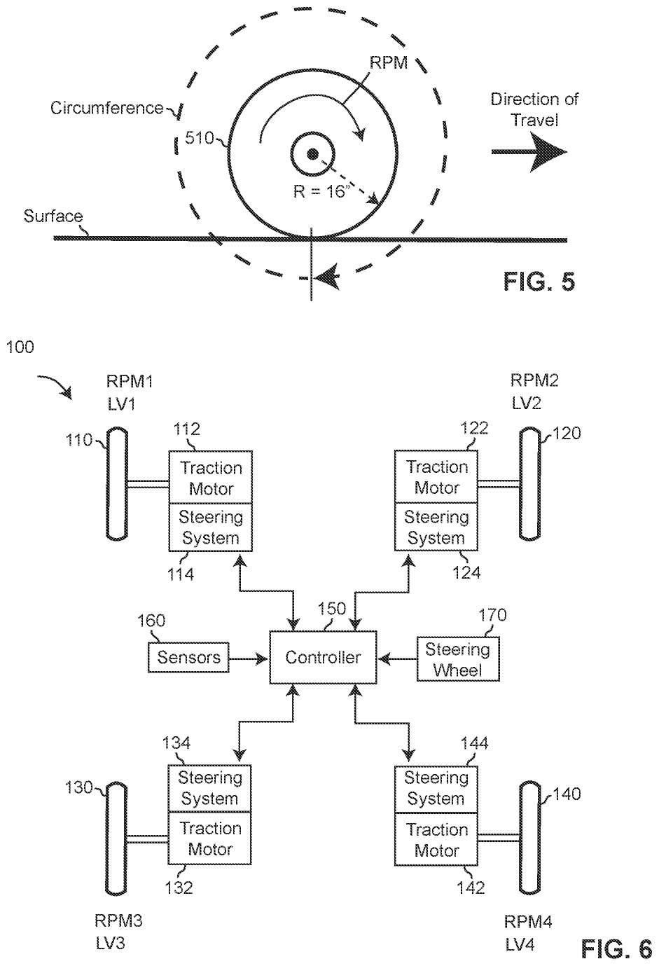

As discussed above, the linear velocity of any one of the wheels 110, 120, 130 and 140 may be calculated by multiplying the circumference of the wheel by the RPMs of the wheel. The calculated linear velocity of a wheel 510, shown in FIG. 5, with a 16-inch radius (i.e., 32-inch diameter) is shown in Table A below. The circumference of the wheel is measured from the center the wheel to the outer surface of the wheel that comes in contact with the road. A wheel with the 16-inch radius has a circumference of 100.531 inches, so as shown below, when the wheel rotates at one RPM, the linear velocity of the wheel is 100.531 inches per minute.

TABLE A
Linear Velocity of a 16-inch Radius Wheel

| | Inches per | Inches per | Miles per |
|---|---|---|---|
| RPM | Second | Minute | Hour |
| 0.01 | 0.0168 | 1.006 | 0.00095 |
| 0.1 | 0.168 | 10.05 | 0.0095 |
| 0.5 | 0.838 | 50.26 | 0.0476 |
| 1 | 1.676 | 100.5 | 0.0952 |
| 2 | 3.351 | 201.1 | 0.1904 |
| 10 | 16.76 | 1005 | 0.952 |
| 100 | 167.55 | 10053 | 9.52 |
| 200 | 335.1 | 20106 | 19.0 |
| 300 | 502.65 | 30159 | 28.6 |
| 400 | 670.21 | 40212 | 38.1 |
| 500 | 837.75 | 50265 | 47.6 |
| 600 | 1005.3 | 60319 | 57.1 |
| 700 | 1172.9 | 70371 | 66.6 |
| 800 | 1340.4 | 80425 | 76.2 |
| 900 | 1508.0 | 90477 | 85.7 |
| 1000 | 1675.5 | 100531 | 95.2 |

The linear velocity of each of the wheels 110, 120, 130 and 140 may be calculated and used to determine the speed of the electric vehicle 100. It is assumed that the radius of all of the wheels 110, 120, 130 and 140 are the same for this analysis. The traction motors 112, 122, 132 and 142 may measure and report their respective rates of revolution RPM1, RPM2, RPM3 and RPM4. The RPM of each wheel 110, 120, 130 and 140 may be used to calculate their respective linear velocity linear velocity LV1, LV2, LV3 and LV4. Under ideal conditions, the linear velocity of all wheels should be about the same, so the linear velocity of the electric vehicle 100 should be the linear velocity of any one of the tires. So, under ideal conditions, the velocity of the electric vehicle 100, VEV is provided in Equation 1 below.

VEV=LV1=LV2=LV3=LV4 Equation 1:

However, conditions (e.g., uneven tread wear, road surface conditions) are rarely ideal. There is bound to be some difference in the velocities measured for the wheels 110, 120, 130 and 140. So, the velocity of the electric vehicle 100, VEV, is the speed of any one of the wheels 110, 120, 130 and 140, as long as the linear velocity of the wheels 110, 120, 130 and 140 is within a threshold. In an example embodiment, the linear velocity of any one wheel 110, 120, 130 or 140 is considered to be equal the linear velocity of any other wheel 110, 120, 130 and 140 if the RPMs of the two wheels are within ±0.01-0.1 revolutions per minute of each other. For example, if the wheel 110 is rotating at 10 RPM and the wheel 120 is rotating at between 9.9 and 10.1 RPM, then the wheels 110 and 120 are considered to be rotating at the same speed and therefore have the same linear velocity. If the wheel 110 is rotating at 10 RPM and the wheel 120 is rotating at a speed less than 9.9 RPM or greater than 10.1 RPM, the wheels 110 and 120 are not considered to be rotating at the same speed and therefore do not have the same linear velocity. The threshold range of 0.01-0.1 RPM, for a tire with a 16-inch radius, translates to a range of 0.017-0.167 inches/second or 1-10.1 inches per minute.

So, if all of the wheels 110, 120, 130 and 140 a rotating at the same RPM± the threshold, then the speed of the electric vehicle 100, VEV, is equal to the linear velocity of any one of the wheels 110, 120, 130 and 140. If only three of the wheels 110, 120, 130 and 140 are rotating at the same RPM± the threshold, then VEV is equal to the linear velocity of any one of the three wheels. If only two of the wheels 110, 120, 130 and 140 are rotating same RPM± the threshold, then VEV is equal to the linear velocity of any one of the two wheels. If all of the wheels 110, 120, 130 and 140 are rotating at different RPMs, then it is difficult to detect the actual speed of the electric vehicle 100 using the rotation of the wheels 110, 120, 130 and 140.

However, the sensors 160 may include a sensor that detects VEV of the electric vehicle 100. The velocity VEV as measured by the sensors 160 may be compared to the linear velocity of the wheels 110, 120, 130 and 140 to determine if the speed of any one wheel 110, 120, 130 and 140 represents the speed of the electric vehicle 100.

### Determining Wheel Slip

The calculated linear velocity of the wheels 110, 120, 130 and 140 may also be used to determine whether one or more of the wheels is slipping. The linear velocity of a wheel that is slipping is greater than the linear velocity of the other wheels. The linear velocity of the wheels 110, 120, 130 and 140 may also be compared to the velocity VEV of the electric vehicle 100 as measured by the sensors 160. Any wheels 110, 120, 130 or 140 that has a linear velocity greater than the VEV of the electric vehicle 100 is slipping. A wheel begins the slip when it loses traction with the road surface. A wheel may lose traction with the road surface when the wheel comes into contact with a portion of the road that has a lower coefficient of friction then the rest of the road. While the electric vehicle 100 is maintaining its speed or accelerating, when a wheel comes into contact with the portion of the road that has the lower coefficient of friction, the power from the traction motor causes the wheel to spin over the surface so that the wheel turns faster. While the electric vehicle 100 is decelerating, when the wheel comes into contact with the portion of the road that has the lower Cove mission of friction, the wheel either stops spinning (e.g., locks up) or spins so that the wheel turns faster.

### Steering Correction for Slip

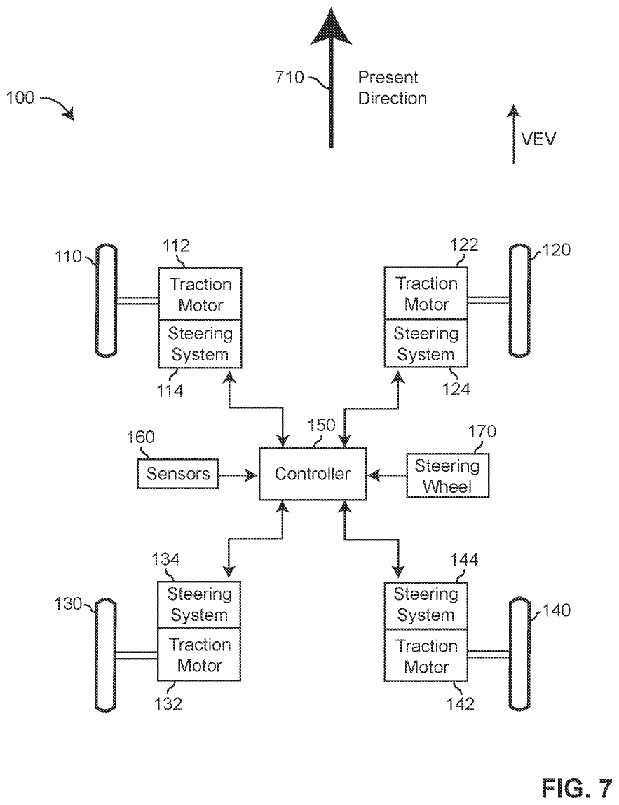

As the electric vehicle 100 either maintains its speed or is accelerating in a present direction 710, referring to FIG. 7, none of the wheels 110, 120, 130 and 140 are slipping, so the electric vehicle 100 proceeds in the present direction 710 of travel at the speed VEV which, as discussed above, is the linear velocity of any one of the wheels 110, 120, 130 and 140. Further, because none of the wheels are slipping, there is no torsion force on the electric vehicle 100. Accordingly, no steering correction need be applied to try to maintain the present direction 710.

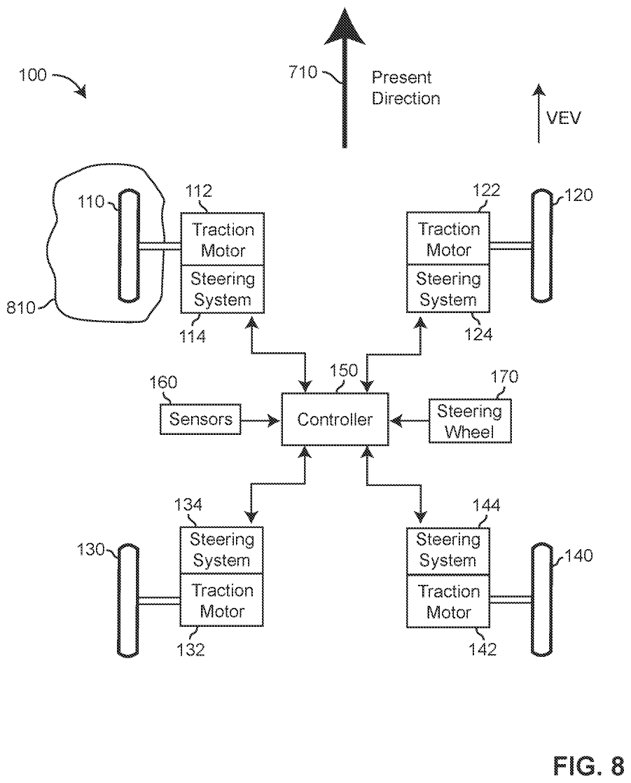

If one of the wheels, for example, the wheel 110, as shown in FIG. 8, encounters a slick 810 on a portion of the road, the linear velocity of the wheel 110 increases and is greater than the linear velocity of the other wheels 120, 130 and 140. The higher linear velocity of the wheel 110 indicates that the wheel 110 is slipping. The velocity VEV of the electric vehicle 100 may still be determined by the linear velocities of the wheels 120, 130 and 140 or by the sensors 160. Because only one wheel is slipping, the other three wheels may continue to propel the electric vehicle 100 in the present direction 710 at the velocity VEV. Further, because only one wheel is slipping no torsion force has developed to act on the electric vehicle 100 to cause the electric vehicle 100 to spin, for example around the z-axis shown in FIG. 4.

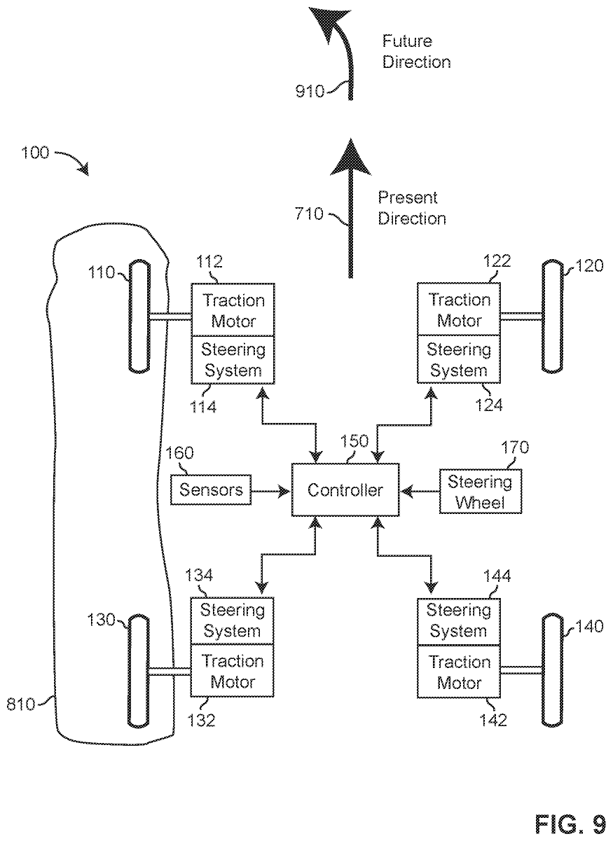

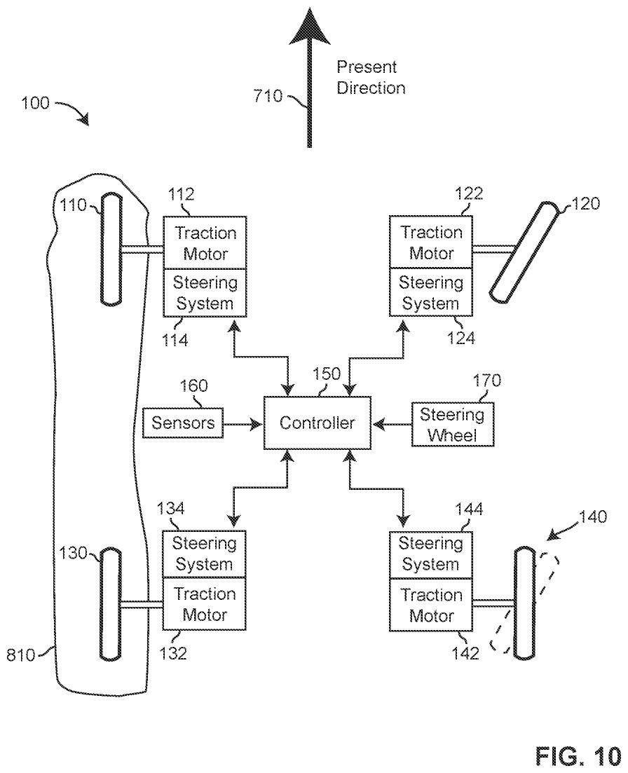

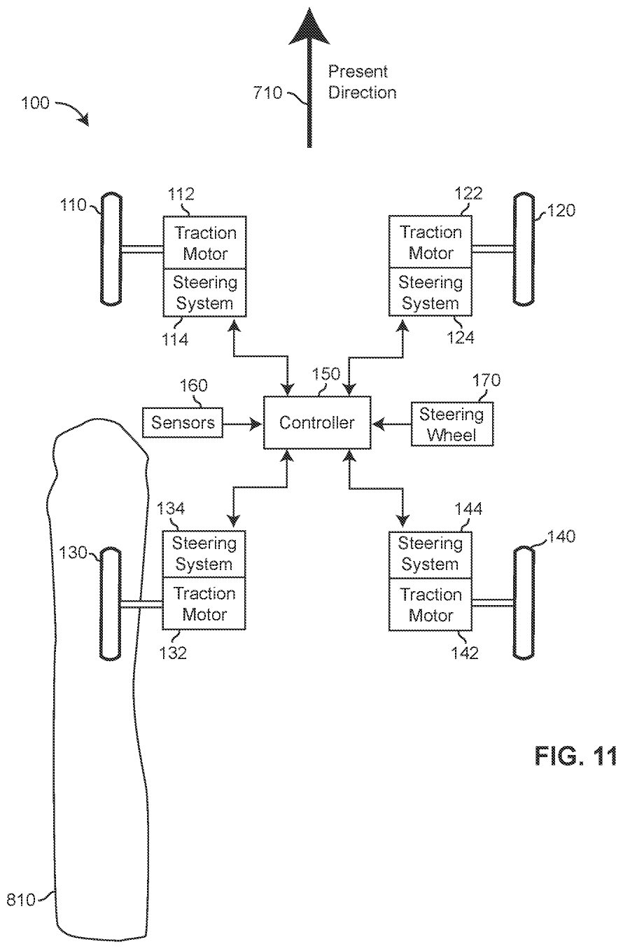

In the event that two wheels, for example, the wheels 110 and 130 as shown in FIG. 9, are both on the slick 810 and begin to slip, the lack of traction for the wheels 110 and 130 combined with the traction and forward rotation of the wheels 120 and 140 results in a torsion force on the electric vehicle 100 in the counterclockwise direction. Before the wheels 110 and 130 begin slipping, the electric vehicle 100 moves forward in the present direction 710. After the wheels 110 and 120 begin slipping, the torsion force 450, refer to FIG. 4, begins to act on the electric vehicle 100. The torsion force 450 in the counterclockwise direction will turn electric vehicle in the counterclockwise direction so that the electric vehicle 100 will change from the present direction 710 to a future direction 910. The slipping of the wheels 110 and 130 results in the vehicle turning (e.g., spinning) counterclockwise so that the electric vehicle 100 begins to travel in the future direction 910 even though all of the wheels 110, 120, 130 and 140 are oriented forward along the present direction 710. Because the wheels are pointed forward, veering to the left is undesirable and likely contrary to the wishes of the driver.

However, it is possible to activate one or more of the steering systems 114, 124, 134 and/or 144 to reduce the torsion force caused by the slip of the wheels 110 and 130. The steering systems 114, 124, 134 and/or 144 may be controlled by the controller 150 to attempt to keep the electric vehicle 100 veering to the left or spinning in a counterclockwise direction. The steering systems 114, 124, 134 and/or 144 may be activated to change the orientation of one or more of the wheels 110, 120, 130 or 140 to counteract the counterclockwise torsion force caused by the slipping of the wheels 110 and 130. The controller 150 may monitor the present direction and may detect, via the sensors 160, the development of the counterclockwise force on the electric vehicle 100 around the z-axis.

Upon detecting slipping of the wheels and/or rotation due to a torsion force, the controller 150 may activate one or more of the steering systems 114, 124, 134 and 144 to attempt to counteract the torsion force. Responsive to the torsion force, discussed with respect to FIG. 9, the controller 150 may control the steering system 124 and/or the steering system 144 to attempt to reduce the counterclockwise force on the electric vehicle 100 so that the electric vehicle 100 continues in the present direction 710 as opposed to veering to the left along the future direction 910. In these circumstances, the controller 150 instructs the steering system 124 to orient the wheel 120 in rightward direction as shown in FIG. 10. The torsion force that results from the slipping of the wheels 110 and 130 causes the electric vehicle 100 to spin in the counterclockwise direction. Orienting the wheel 120 in the rightward direction causes the wheel 120 to pull in a direction opposite to the direction of the spin of the electric vehicle 100 that results from the torsion force.

As discussed above, the steering systems 114, 124, 134 and 144 may operate independent of each other, so the controller 150 may also instruct the steering system 144 to orient the wheel 140 toward the rightward direction to help counteract the torsion force. In an embodiment, the controller 150 orients the wheel 120 and the wheel 140 toward the rightward direction to compensate for (e.g., counteract) the counterclockwise torsion force on the electric vehicle 100. The controller 150 may monitor the direction of travel, the rotation of the electric vehicle 100 and/or the magnitude of the torsion force to determine how much the wheels 120 and/or 140 should be oriented rightward.

In an embodiment, the controller 150 could also instruct the steering systems 114 and 134 to orient the wheels 110 and 130 toward the rightward direction in an attempt to further counteract the torsion force; however, as the wheels 110 and 130 are slipping on the slick 810, changing their orientation may not significantly help counteract the torsion force. In an example embodiment, the controller 150 does not alter the orientation of the wheels that are slipping. In another example embodiment, the controller 150 orients all tires to attempt to counteract the torsion force regardless of whether the tire is slipping or not.

As the wheel 110 moves past the slick 810, the controller 150 detects that wheel 110 is no longer slipping. The controller 150 may further detect a decrease in the torsion force. As the torsion force decreases, the controller 150 returns the orientation of the wheels 120 and/or 140 to the forward direction. The controller 150 detects wheel slippage and/or the rotation of the electric vehicle 100 and orients at least the wheels 120 and 140 to compensate for the torsion force with no input from the driver. The controller 150 may orient the wheels that are not slipping in any direction to counteract the torsion force. However, generally, the wheels are oriented in a direction opposite the direction the electric vehicle 100 will turn responsive to the torsion force.

Using the orientation of the wheels to compensate for a torsion force is not limited to the instances in which the electric vehicle 100 is traveling straight ahead. If well the electric vehicle 100 is making a turn, one or more of the wheels begin to slip and a torsion force develops, the controller 150 may orient one or more wheels in an attempt to decrease the torsion force that results from the slipping. Further, using the orientation of the wheel to compensate for torsion force is not limited to instances in which the electric vehicle 100 is maintaining its speed or accelerating. The controller 150 may detect a torsion force and orient one or more wheels to reduce the torsion force even during braking and deceleration.

As the controller 150 controls the steering systems to reduce the torsion force, the controller 150 may further receive information as to direction of travel of the vehicle from the steering wheel 170. The controller 150 may determine a desired direction of travel as indicated by information from the steering wheel 170. The controller 150 may control the steering systems to orient the wheels to travel the desired direction as indicated by the steering wheel 170 while still controlling the orientation of one or more wheels in an attempt to reduce the torsion force.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. An electric vehicle, comprising:
a controller;
a gyroscope, the gyroscope configured to provide a first data to the controller regarding a torsion force on the electric vehicle;
four wheels;
four traction motors, one traction motor coupled to one wheel respectively, each traction motor adapted to provide a second data to the controller regarding a revolutions per minute of the respective wheel coupled to the traction motor; and
four steering systems, one steering system coupled to one wheel respectively, each steering systems adapted to receive a third data from the controller for orienting the respective wheel coupled to the steering system; wherein:
upon receiving the first data regarding the torsion force, the controller provides the third data to one or more of the four steering systems to orient one or more of the wheels that are not slipping in a direction to reduce the torsion force.

2. The electric vehicle of claim 1 wherein the torsion force results from one or more wheels slipping.

3. The electric vehicle of claim 2 wherein the controller orients the one or more of the four wheels that are not slipping in the direction opposite a direction of rotation of the torsion force.

4. The electric vehicle of claim 3 wherein while the direction of rotation of the torsion force is counterclockwise, the controller orients one or more of the four wheels that are not slipping at an angle in a rightward direction.

5. The electric vehicle of claim 3 wherein while the direction of rotation of the torsion force is clockwise, the controller orients one or more of the four wheels that are not slipping at an angle in a leftward direction.

6. The electric vehicle of claim 1 wherein the controller uses the second data from the four traction motors to determine a velocity of the electric vehicle.

7. The electric vehicle of claim 1 wherein the controller compares the second data from the four traction motors to determine whether one or more of the four wheels is slipping.

8. The electric vehicle of claim 7 wherein the controller uses the second data from the four traction motors to determine whether one or more of the four wheels is slipping.

9. The electric vehicle of claim 1 further comprising a sensor adapted to detect a velocity of the electric vehicle, wherein:
the sensor provides a fourth data to the controller regarding the velocity of the electric vehicle; and
the controller uses the second data from the four traction motors and the fourth data to determine whether one or more of the four wheels are slipping.

10. An electric vehicle, comprising:
a controller;
one or more sensors configured to detect a speed of the electric vehicle and a torsion force on the electric vehicle, the one or more sensors configured to provide a first data regarding the speed and the torsion force to the controller;
at least three wheels;
at least three traction motors, one traction motor coupled to one wheel respectively, each traction motor configured to detect a number of revolutions per minute of the respective wheel coupled to the traction motor, the at least three traction motors configured to provide a second data regarding the number of revolutions per minute to the controller; and
at least three steering systems, one steering system coupled to one wheel respectively, each steering systems configured to orient the respective wheel coupled to the steering system, the at least three steering systems configured to receive a third data from the controller for orienting at least one of the at least three wheels; wherein:
responsive to the first data regarding the speed and the second data regarding the number of revolutions per minute, the controller determines which wheels are not slipping; and
responsive to the first data regarding the torsion force, the controller provides the third data to one or more of the at least three steering systems to orient one or more of the wheels that are not slipping in a direction to reduce the torsion force.

11. The electric vehicle of claim 10 wherein the controller orients the one or more of the wheels that are not slipping in the direction opposite a direction of rotation of the torsion force.

12. The electric vehicle of claim 11 wherein while the direction of rotation of the torsion force is counterclockwise, the controller instruct one or more of the at least three steering systems via the third data to orient one or more of the at least three wheels that are not slipping at an angle in a rightward direction.

13. The electric vehicle of claim 11 wherein while the direction of rotation of the torsion force is clockwise, the controller instructs one or more of the at least three steering systems via the third data to orient one or more of the at least three wheels that are not slipping at an angle in a leftward direction.

14. The electric vehicle of claim 10 wherein the controller uses the speed from the first data and the number of revolutions per minute for each wheel from the second data to determine which wheels are slipping.

15. The electric vehicle of claim 14 wherein the controller:
uses the number of revolutions per minute for each wheel to determine a linear velocity for each wheel;
compares the linear velocity for each wheel to the speed from the first data; and
identifies each wheel that has the linear velocity greater than the speed from the first data as slipping.

16. The electric vehicle of claim 10 wherein the controller:
determines whether the number of revolutions per minute of each wheel is within a threshold of the number of revolutions per minute of any other wheel;
determines a linear velocity for each wheel having the number of revolutions per minute within the threshold; and
uses the linear velocity of any one wheel having the number of revolutions per minute within the threshold as the speed of the electric vehicle.
